(19) United States
(12) Patent Application Publication
(10) Pub. No.: US 2025/0053846 A1
(43) Pub. Date: Feb. 13, 2025

(54) CONTROL METHOD OF ELECTRONIC APPARATUS AUTHENTICATING OUTPUT OF CLASSIFIER BY USING ORTHOGONAL INPUT ENCODING

(71) Applicant: SAMSUNG ELECTRONICS CO., LTD., Suwon-si (KR)

(72) Inventors: Mehul Kumar, Suwon-si (KR); Aditya Sahdev, Suwon-si (KR); James Russell Geraci, Suwon-si (KR)

(73) Assignee: SAMSUNG ELECTRONICS CO., LTD., Suwon-si (KR)

(21) Appl. No.: 18/930,763

(22) Filed: Oct. 29, 2024

Related U.S. Application Data
(63) Continuation of application No. PCT/KR2023/004418, filed on Apr. 3, 2023.

(30) Foreign Application Priority Data
Apr. 29, 2022 (KR) 10-2022-0053775
Oct. 31, 2022 (KR) 10-2022-0143076

(51) Int. Cl. G06N 10/60; G06N 10/40

(52) U.S. Cl. CPC G06N 10/60; G06N 10/40

(57) ABSTRACT

An electronic apparatus, including: an input interface; and at least one processor configured to: receive bit-format input data using the input interface, convert input bits included in the input data to obtain input qubits, encode the input qubits to obtain encoded qubits, estimate quantum amplitude values of a predetermined number of the input qubits using a quantum neural network (QNN) based on the encoded qubits, determine a probability value corresponding to the data based on the estimated quantum amplitude values, and authenticate the input data by comparing the determined probability value with a predetermined authentication radius value

### CROSS-REFERENCE TO RELATED APPLICATIONS

This application is a continuation of International Application No. PCT/KR2023/004418, filed on Apr. 3, 2023, in the Korean Intellectual Property Receiving Office, which is based on and claims priority to Korean Patent Application Number 10-2022-0053775 filed on Apr. 29, 2022, and Korean Patent Application No. 10-2022-0143076 filed on Oct. 31, 2022, in the Korean Intellectual Property Office, the disclosures of which are incorporated by reference herein in their entireties.

### BACKGROUND

### 1. Field

The present disclosure relates to an electronic apparatus authenticating output of a classifier by using orthogonal input encoding, and a control method thereof.

### 2. Description of Related Art

As an amount of information is increased, performing calculations using a general system may become more time-consuming. In accordance with the advancement of an electronic technology, a system having improved performance is being developed, and a new calculation method such as parallel computing is being designed. However, a user may wish to compute more information to consider various possibilities and acquire more accurate results.

Quantum computing is a technology that may overcome these limitations. In an some systems, a basic unit of the information may be a bit, and the bit may have one of two values, for example a value of “0” and a value of “1”. However, in quantum computing, a basic unit of information may be a qubit, and a qubit may have one of three values, for example a value of “0”, value of “1”, and a quantum superposition value of the values “0” and “1”. In addition, quantum computing may be used to perform calculations based on properties of quantum physics. For example, quantum computing may exponentially improve a calculation speed compared to other systems according to quantum properties of superposition, interference, and entanglement.

### SUMMARY

In accordance with an aspect of the disclosure, an electronic apparatus includes: an input interface; and at least one processor configured to: receive bit-format input data using the input interface, convert input bits included in the input data to obtain input qubits, encode the input qubits to obtain encoded qubits, estimate quantum amplitude values of a predetermined number of the input qubits using a quantum neural network (QNN) based on the encoded qubits, determine a probability value corresponding to the data based on the estimated quantum amplitude values, and authenticate the input data by comparing the determined probability value with a predetermined authentication radius value.

The at least one processor may include: a state preparation module configured to superpose the input qubits to obtain superposed qubits, a diffusion module group configured to estimate the quantum amplitude values using the QNN based on the superposed qubits, and a measurement module configured to determine the probability value based on the estimated quantum amplitude values.

The state preparation module may be further configured to: receive a first plurality of qubits from among the input qubits, and distribute the received first plurality of qubits and a second plurality of qubits to have a predetermined distribution centered on an average of the first plurality of qubits and the second plurality of qubits.

The diffusion module group may include a predetermined number of diffusion modules, and each diffusion module included in the predetermined number of diffusion modules may be configured to output an estimated quantum amplitude value.

The diffusion module may include at least one of a QNN module, an inverse state preparation module, a search operator module, and the state preparation module.

The measurement module may include an inverse quantum Fourier transform (IQFT) module configured to identify the probability value corresponding to the data by superposing the quantum amplitude values.

In accordance with an aspect of the disclosure, a method for controlling an electronic apparatus, includes: receiving bit-format input data; converting input bits included in the input data to obtain input qubits; encoding the input qubits to obtain encoded qubits; estimating quantum amplitude values of a predetermined number of the input qubits using a quantum neural network (QNN) based on the encoded qubits; determining a probability value corresponding to the data based on the estimated quantum amplitude values; and authenticating the input data by comparing the determined probability value with a predetermined authentication radius value.

The encoding may include: receiving a first plurality of of qubits from among the input qubits; and distributing the first plurality of qubits and a second plurality of qubits to have a predetermined distribution centered on an average of the first plurality of qubits and the second plurality of qubits, and each qubit of the first plurality of qubits and the second plurality of qubits may be superposed.

The method may further include outputting the estimated quantum amplitude values, and a number of the estimated quantum amplitude values may correspond to a predetermined number of diffusion modules included in the electronic apparatus.

The determining of the probability value may include performing an inverse quantum Fourier transform (IQFT) process determine the probability value by superposing the quantum amplitude values.

### BRIEF DESCRIPTION OF THE DRAWINGS

FIG. 1 is a block diagram for explaining a configuration of an electronic apparatus according to an embodiment of the present disclosure;

FIG. 2 is a diagram for explaining a quantum circuit according to an embodiment of the present disclosure;

FIG. 3 is a diagram for explaining a state preparation module according to an embodiment of the present disclosure;

FIG. 4 is a diagram for explaining an input loader according to an embodiment of the present disclosure;

FIG. 5 is a diagram for explaining a diffusion module according to an embodiment of the present disclosure;

FIG. 6 is a diagram for explaining an authentication radius corresponding to an input state according to an embodiment of the present disclosure; and

FIG. 7 is a flow chart for explaining a control method of an electronic apparatus according to an embodiment of the present disclosure.

### DETAILED DESCRIPTION

Hereinafter, various embodiments are described in more detail with reference to the accompanying drawings. The embodiments described in the specification may be modified in various ways. A specific embodiment may be shown in the drawings and described in detail in a detailed description. However, the specific embodiment disclosed in the accompanying drawings is provided only to assist in easy understanding of the various embodiments. Therefore, it should be understood that the spirit of the present disclosure is not limited by the specific embodiment shown in the accompanying drawings, and includes all the equivalents and substitutions included in the spirit and scope of the present disclosure.

Terms including ordinal numbers such as “first” and “second” may be used to describe various components. However, these components are not limited by these terms. The terms are used only to distinguish one component and another component from each other.

It should be understood that terms “include” and “have” used in the specification specify the presence of features, numerals, steps, operations, components, parts, or combinations thereof, mentioned in the specification, and do not preclude the presence or addition of one or more other features, numerals, steps, operations, components, parts, or combinations thereof. It is to be understood that if one component is referred to as being “connected to” or “coupled to” another component, one component may be directly connected to or directly coupled to another component, or may be connected to or coupled to another component while having a third component interposed therebetween. On the other hand, it is to be understood that if one component is referred to as being “directly connected to” or “directly coupled to” another component, one component may be connected or coupled to another component without a third component interposed therebetween.

Meanwhile, a term “module” or an element with a name ending in a suffix such as “-er” and “-or” (which may be referred to as an “-er/-or” element)used in the specification may perform at least one function or operation. In addition, the “module” or “-er/-or” element may perform the function or operation by hardware, software, or a combination of hardware and software. In addition, a plurality of “modules” or a plurality of “-ers/-ors” elements except for a module” or “-er/-or” element performed by specific hardware or performed by at least one processor may be integrated into at least one module. A term of a single number may include its plural number unless explicitly indicated otherwise in the context.

In describing the present disclosure, a sequence of each operation should be understood as non-restrictive unless a preceding operation in the sequence of each operation must logically and temporally precede a subsequent operation. For example, except for the above exceptional case, a process described as a subsequent operation may be performed before a process described as the preceding operation, and the scope of the present disclosure encompasses any sequence of the operations. In addition, in the specification, “A or B” may be defined to indicate not only selectively indicating either one of A and B, but also including both A and B. In addition, a term “including” in the specification may have a meaning encompassing further including other components in addition to components listed as being included.

The scope of the disclosure may include some components which are not described below. In addition, it should not be interpreted as an exclusive meaning that the present disclosure includes only the mentioned components, but should be interpreted as a non-exclusive meaning that the present disclosure may include other components as well.

Further, in describing the present disclosure, a detailed description of some aspects which may unnecessarily obscure or complicate the description of the present disclosure may be summarized or omitted. Meanwhile, the respective embodiments may be implemented or operated independently, and may be implemented or operated in combination.

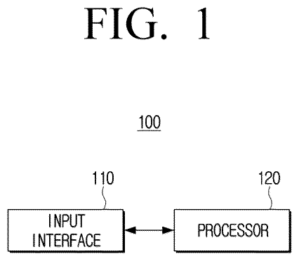

FIG. 1 is a block diagram for explaining a configuration of an electronic apparatus according to an embodiment of the present disclosure.

Referring to FIG. 1, an electronic apparatus 100 may include an input interface 110 and a processor 120. For example, the electronic apparatus 100 may include a server, a cloud, or the like.

The input interface 110 may receive a control command from a user. For example, the input interface 110 may receive a control command for a function of the electronic apparatus 100, a selection command for information related to an operation of the electronic apparatus 100, or the like. For example, the input interface 110 may include a keyboard, a button, a key pad, a touch pad, or a touch screen. In some embodiments, the input interface 110 may be implemented as an input port (or input/output port) or a communication interface to thus receive data to be verified. The data received through the input interface 110 may be bit-format data or qubit-format data.

In case that the input interface 110 is implemented as the input port, the input port may include a high-definition multimedia interface (HDMI), a displayport (DP), a red-green-blue (RGB) port, a digital visual interface (DVI), a universal serial bus (USB), a Thunderbolt, an audio jack, a video jack, or the like. In case that the input interface 110 is implemented as the communication interface, the communication interface may perform communication with an external device, and receive the data to be verified from the external device. For example, the communication interface may perform the communication with the external device on the basis of a communication standard such as wireless-fidelity (Wi-Fi), Wi-Fi direct, Wi-Fi Aware, 3rd generation (3G), 3rd Generation Partnership Project (3GPP), long term evolution (LTE), Bluetooth, Zigbee, near field communication (NFC), or a local area network (LAN). The input interface 110 may also be referred to as an input device, an inputter, an input module, or the like.

The electronic apparatus 100 may include at least one processor 120. The processor 120 may control each component of the electronic apparatus 100. For example, the processor 120 may control the input interface 110 to receive the data to be verified. In case that the input data has the bit format, the processor 120 may convert the input data to the qubit-format data.

The processor 120 may encode the qubit-format data converted from the input bit-format data or the input qubit-format data. For example, the processor 120 may superpose each qubit of the data whose bits are converted to qubits. In addition, the processor 120 may receive a first number of qubits, and distribute the first number of qubits and a second number of qubits to have predetermined distribution centered on the average of the first number of input qubits and the second number of qubits.

The processor 120 may estimate a quantum amplitude value of a predetermined number of qubits by using a quantum neural network (QNN) based on the encoded qubit. In addition, the processor 120 may estimate the quantum amplitude value of the predetermined number of qubits by using the quantum neural network (QNN) based on a superposed qubit. The processor 120 may include a predetermined number of diffusion modules, and output estimated quantum amplitude values whose number corresponds to the predetermined number of diffusion modules.

The processor 120 may determine a probability value of the data based on the predetermined number of estimated quantum amplitude values. The processor 120 may identify the probability value of the data by superposing the output quantum amplitude values of the predetermined number of qubits. The processor 120 may authenticate the input data by comparing the identified probability value with a predetermined authentication radius value.

In addition, the electronic apparatus 100 may further include a memory and a display.

The memory may store data, algorithms, or the like that perform the functions of the electronic apparatus 100, and store programs, commands, or the like that are driven in the electronic apparatus 100. For example, the memory may store a quantum circuit implemented in software, an algorithm that estimates the probability value, the authentication radius value (or algorithm) corresponding to the input data, or the like. The algorithms or data stored in the memory may be loaded into the processor 120 under control of the processor 120 to perform related functions. For example, the memory may be implemented in the form of a read-only memory (ROM), a random access memory (RAM), a hard disk drive (HDD), a solid-state drive (SSD), a memory card, or a quantum memory.

The display may output the data processed by the processor 120 as an image. The display may display information related to the input data authentication. For example, the display may be implemented as a liquid crystal display (LCD), an organic light emitting diode (OLED) display, a flexible display, a touch screen, or the like. In case that the display is implemented as the touch screen, the electronic apparatus 100 may receive the control command through the touch screen.

Hereinafter, examples of the quantum circuit included in the processor 120 are described.

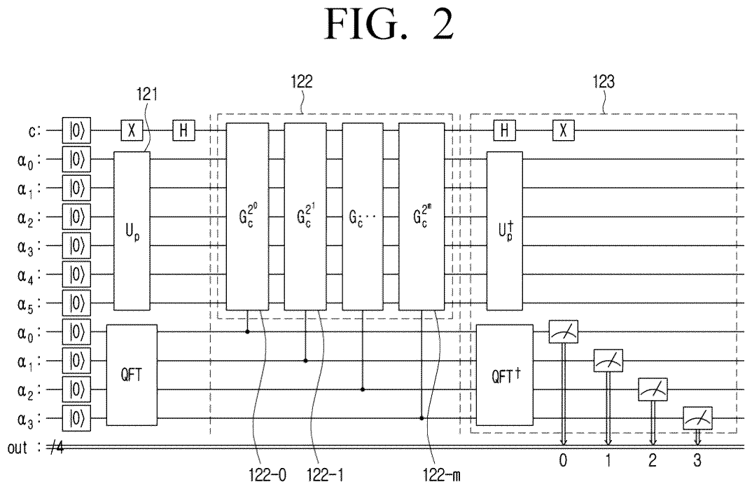

FIG. 2 is a diagram for explaining the quantum circuit according to an embodiment of the present disclosure.

In the present disclosure, a classical input transformed by an adversary attack may be encoded into a quantum computing state to thus quickly output a result value. In addition, in the present disclosure, the input data may be authenticated by comparing the output value with the authenticated radius. In the present disclosure, randomized smoothing may be implemented by using the quantum computing, and the input data (e.g., image) may be expressed as a tensor product for the input data to be orthogonal to each other. In the present disclosure, a smoothing neighborhood of the input data may be superposed, and an average prediction probability for a class ρ_{c} may be output using the quantum circuit. For example, the input data may be an image part or a neighborhood image part of the image part for authenticating whether the input data belongs to the class.

The electronic apparatus 100 may include an algorithm such as quantum amplitude estimation, Grover diffusion operator, and quantum Fourier transform. The electronic apparatus 100 of the present disclosure is intended to protect a quantum computing classifier from a hostile attack.

Symbols used in the present disclosure may have the following meanings:
d: Input vector dimension.
v: Resolution of a single value in the input vector. For example, for a black and white image input, each value ranges from 0-256, and accordingly, v=8. For an RGB image input, inputs of v=24 are maintained to be orthogonal to each other in the qubits.
xⱼᵢ: I-th classical bit in j-th input value.
σᵢ: I-th Pauli matrix. For example, σ₀=II, and σ₁=X.
ILⱼ: Single-pixel loader in the classic bits, ILⱼ=ILⱼ=⊗ᵢ₌₀^{v-1}σ_{αjl}
   |αⱼ>: J-th pixel value such that ILⱼ|0>=|αⱼ>.
Sₚⱼ: Smoothing calculation for a pixel.
βⱼₖ: Neighborhood of αⱼ after smoothing as βⱼₖ=αⱼ+δₚₖ, where, δₚₖ corresponds to basic p-distribution (underlying p-distribution) whose average is 0.
wⱼₖ: Smoothing distribution for pixel j, where Sₚⱼ|αⱼ [symbol] =Σₖ^{2″-1}\sqrt{wⱼₖ}|βⱼₖ [symbol] .
Uₚⱼ: Uₚⱼ=ILⱼSₚⱼ, where single pixel state preparation is Uₚⱼ|0=Σₖ²^{^{v}}⁻¹\sqrt{wⱼₖ}|βⱼₖ [symbol]
Up: State preparation circuit (module), where Uₚ⊗ⱼ₌₀^{d-1}Uₚⱼ.
z: Number of auxiliary qubits.
   |i>: qubit expression of value i, which is a bit string in an input space. |ψ>=Σᵢ²^{^{dv}}⁻¹\sqrt{pᵢ}|i [symbol] after the smoothing, and a probability weight i of the distribution used for the smoothing is pi=w₁ₖ₁w₂ₖ₂ . . . , w_{dkd}. There is a total of 2^{dv} inputs to the superposition.
fc(x): Default binary classifier for class c designated for fc(x)=1<=>x to belong to class c.
QNNc: unitary quantum neural network oracle. QNNc|x>|−>=(−1)^{f(x)}|x>|−>.
ρ_{c}: Probability that the default classifier responds with class c in case that the input is perturbed with smoothing noise δ, i.e., ρ_{c}=P(f_{c}(x+δ)=1).
Lₚ: Description of an adversary. That is, the adversary may select a point within distance F from a valid input defined by an Lₚ norm.
Uₚ: Smoothing single operator (quantum circuit) for a given Lₚ adversary.
G_{pc}: Grover search operator, which is an iterative component in an amplitude estimation problem of finding pc for class c. G_{pc}=Uₚ(2|0><0|−II)Up⁺ QNNc.

Referring to FIG. 2, the quantum circuit included in the processor 120 may include a state preparation module 121, a diffusion module group 122 including a predetermined number of diffusion modules 122-0, 122-1, . . . , and 122-m, and a measurement module 123. The quantum circuit may be implemented in hardware or software. “X” included in FIG. 2 may be a Pauli X gate, and “H” may be a Hadamard gate. Each block of the quantum circuit shown in FIG. 2 may be referred to as a module, a block, a gate, a circuit, or the like. A state preparation module Up and an inverse state preparation module Uₚ⁺ or a quantum Fourier transform module (QFT) and an inverse quantum Fourier transform module (QFT⁺) may be a common pair of a pre-processing circuit or a post-processing circuit. The common pair module may serve to maintain the processed data to be in a specific state.

The state preparation module 121 may convert bits of the input bit-format data to qubits. In addition, the state preparation module 121 may superpose each qubit of the data having bits converted qubits.

For example, the state preparation module 121 may receive 4-bit data of 0101 (=5). In addition, the state preparation module 121 may encode 4 qubits of |0101>. An input data value is 5, and the probability distribution of the qubit may thus be in a form where a probability is decreased centered on 5. The state preparation module 121 may superpose each qubit. For example, based on the converted qubit, the state preparation module 121 may perform the superposition such as 0.19|0001>+0.26|0010>+0.36|0011>+0.43|0100>+0.46|0101>+0.43|0110>+0.36|0111>+0.26|000>+0.19|001>.

The diffusion module group 122 may estimate the quantum amplitude value of the predetermined number of qubits by using the QNN based on the superposed qubit. The diffusion module group 122 may include one or more diffusion modules (or diffusion operators) 122-0, 122-1, . . . , and 122-m. In an embodiment, the electronic apparatus 100 may use Grover search algorithm. In this case, the diffusion modules 122-0, 122-1, . . . , or 122-m may be a Grover diffusion module (operator) including a Grover search operator G_{pc}.

Each of the diffusion modules 122-0, 122-1, . . . , and 122-m may output the estimated quantum amplitude value.

The measurement module 123 may identify the probability value of the input data based on the quantum amplitude value output from each diffusion module 122-0, 122-1, . . . , or 122-m.

The electronic apparatus 100 may include the predetermined authentication radius value corresponding to the input data. The processor 120 may authenticate the input data by comparing the identified probability value with the predetermined authentication radius value. For example, the predetermined authentication radius value may be 0.5 and the identified probability value of the input data may be 0.7. In this case, the identified probability value is greater than the predetermined authentication radius value, and the processor 120 may thus authenticate the input data belongs to a determined class. The identified probability value of the input data may be 0.3. In this case, the identified probability value is smaller than the predetermined authentication radius value, and the processor 120 may thus authenticate that the input data does not (or is unable to be determined to) belong to the determined class.

Hereinafter, examples of each module are described in detail.

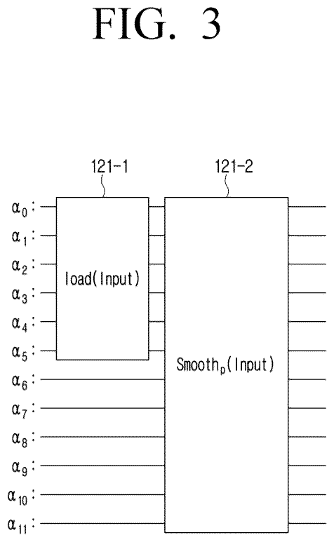

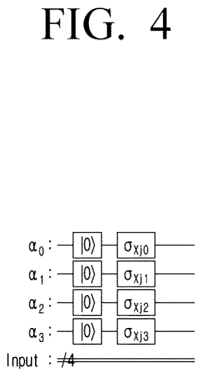

FIG. 3 is a diagram for explaining the state preparation module according to an embodiment of the present disclosure, and FIG. 4 is a diagram for explaining an input loader included in the state preparation module according to an embodiment of the present disclosure.

Referring to FIG. 3, the state preparation module 121 may include an input loader 121-1 and a smoothing module 121-2. FIG. 4 shows an embodiment of the input loader 121-1.

The input loader 121-1 may receive the first number of qubits (e.g., α₀ to α₅), and the smoothing module 121-2 may distribute the first number of qubits and the second number of qubits to have the predetermined distribution centered on the average of the first number of input qubits and the second number of qubits (e.g., α₆ to α11). FIG. 3 or 4 shows a circuit for implementing the following algorithm.

The electronic apparatus 100 may encode the input data into a qubit state orthogonal to other input data by using the input loader 121-1 shown in FIG. 3 or 4. In addition, the electronic apparatus 100 may perform smoothing calculation based on noise distribution selected using the smoothing module 121-2. The electronic apparatus 100 may use the state preparation module (algorithm) corresponding to an input data state (or feature) (e.g., L₀, L₁, or L₂). The input data state is described below.

The electronic apparatus 100 may encode the input data into the qubit state orthogonal to other input data by using the input loader 121-1, and then perform a smoothing operation based on the selected noise distribution by using the smoothing module 121-2.

In an embodiment, the electronic apparatus 100 may use the Grover search algorithm. Grover diffusion operator (Grover algorithm) may perform a search only if unique values in the input space are orthogonal to each other. The smoothing module 121-2 may encode the input data so that a probability of state i in its neighborhood is an amplitude for |i> by mapping a probability distribution defined for a neighborhood area of the input data.

Before the state preparation, a state qubit and an additional qubit (ancilla) may be reset to |0>. The input loader 121-1 may load input I from a classic bit to the qubit state. The superposition of a smoothing neighborhood of the input I based on distribution Φ(λ) may be prepared based on a parameter λ set to correspond to the adversary of the given lₚ norm. Each value |i> in the neighborhood may be a valid input (e.g., perturbed image) of a basic classifier.

d may be defined as a size of the input vector I. For example, d=image height*image width, and the input may be a bitmap [α₀, α₁, α₂, . . . , and α_{d-1}]. The input may be encoded as a qubit state |ψ> as in Equation 1.

$$\vert ψ 〉 = \vert {α}_{0} {α}_{1} {α}_{2} ... . {α}_{d - 1} 〉 = {{⊗}^{d - 1}}_{j = 0} \vert {α}_{j} 〉 . \qquad ( Equation 1 )$$

v may be the number of qubits used to represent an arbitrary αⱼ for all input values in Equation 1. For a black and white image, v may be a resolution of a single pixel in the input, and v=8 if each pixel falls in a range 0-255 (that is, [0, 2⁸−1]).

The j-th value of input I may be expressed as αⱼ=cⱼ₀cⱼ₁ . . . cjᵥ₋₁ (i.e., cⱼᵢ: i-th classic bit of αⱼ). Here, σᵢ generally indicates an i-th Pauli operator having σ₀=II and σ₁=X. An input loader ILⱼ, which loads αⱼ into the qubit state, may be expressed as the tensor product of σᵢ as shown in Equation 2 based on the definition of ILⱼ|0>^{v}=| αⱼ>.

$${IL}_{j} = {{⊗}^{v - 1}}_{i = 0} {σ}_{cji} . \qquad ( Equation 2 )$$

Each value of the input vector I may be loaded independently, and a complete input loader IL operator 121-1 may thus be expressed as in Equation 3 and Equation 4 below.

$$IL = {{⊗}^{d - 1}}_{j = 0} {IL}_{j} . \qquad ( Equation 3 )$$

$${IL \vert 0 〉}^{dv} = \vert {α}_{0} {α}_{1} {α}_{2} ... . {α}_{d - 1} 〉 = \vert ψ 〉 . \qquad ( Equation 4 )$$

The input loader IL 121-1 may include up to vd 1-qubit X gates. If ∥I∥₁=k for an arbitrary input I, the input loader 121-1 may include k X gates corresponding to each |1> of |ψ>.

After the input loader 121-1, a smoothing circuit (module) S^{p,λ} having distribution Φ defined by p, λ may be expressed as in Equation 5.

$${S}_{j}^{p , λ} \vert {α}_{j} 〉 = {\sum }_{k = 0}^{{2}^{v} - 1} \sqrt{{ϕ}_{j} ( {δ}_{k} )} \vert {α}_{j} + {δ}_{k} 〉 . \qquad ( Equation 5 )$$

Here, αⱼ+δₖ may be a neighborhood value of αⱼ. A smoothing module S^{p,λ} 121-2 may independently map each value αⱼ of the input vector to probability weighted superposition of its neighbor. For an arbitrary i in the input space, a probability weight of i in a smoothed qubit state may be expressed as Φ(i)=πⱼΦⱼ(iⱼᵥiⱼᵥ₊₁ . . . i₍ⱼ₊₁₎ᵥ₋₁). Accordingly, Equation 6 below may hold.

$${S}^{p , λ} \vert ψ 〉 = {{⊗}^{d}}_{j = 0} {S}_{j}^{p , λ} \vert {α}_{j} 〉 = {\sum }_{i = 0}^{{2}^{dv} - 1} \sqrt{ϕ ( i )} \vert i 〉 . \qquad ( Equation 6 )$$

Every Φⱼ may have the same distribution centered on average αⱼ.

A combination of the input loader IL 121-1 and the smoothing module S^{p,λ} 121-2 may be expressed as a qubit state preparation operator U^{p,λ} as shown in Equation 7.

$${U}^{p , λ} = {{⊗}^{d - 1}}_{j = 0} {U}_{j}^{p , λ} = {{⊗}^{d - 1}}_{j = 0} {S}_{j}^{p , λ} {IL}_{j} . \qquad ( Equation 7 )$$

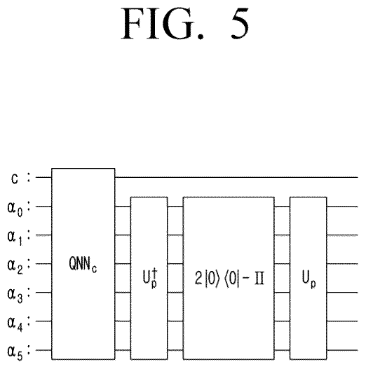

FIG. 5 is a diagram for explaining the diffusion module according to an embodiment of the present disclosure.

Referring to FIG. 5, the diffusion module (or Grover diffusion operator) may include a QNN module, the inverse state preparation module, a search operator (or Grover search operator) module, or the state preparation module. The diffusion module may be included in the diffusion module group 122, and the plurality of diffusion modules may be included in the diffusion module group 122. Each diffusion module included in the diffusion module group 122 may output the estimated quantum amplitude value. FIG. 5 shows a circuit for implementing the following algorithm.

The electronic apparatus 100 may include a quantum machine learning (QML) classifier for class c provided by the unitary quantum parallel oracle QNNc based on the Grover algorithm and a quantum amplitude estimation method. As shown in Equation 8, a QML classifier may be expressed as fc(x)=1 if input x is class c, and fc(x)=0 if input x is not class c.

$${QNN}_{c} \vert x 〉 \vert y 〉 = \vert x 〉 \vert y ⊕ {f}_{c} ( x ) 〉 . \qquad ( Equation 8 )$$

If |y>=|−>, it may be expressed as in Equation 9.

$${QNN}_{c} \vert x 〉 \vert - 〉 = {( - 1 )}^{{f}_{c} ( x )} \vert x 〉 \vert - 〉 . \qquad ( Equation 9 )$$

A smoothed superposition of the input given by U^{p,λ}|0>^{dv} may be applied to QNNc. In this case, ρ_{c} shown in Equation 10 may be an expected probability output that input |x+δ> of the smoothing neighbor belongs to class c.

$${ρ}_{c} = 𝔼 ( ℙ ( {f}_{c} ( x + δ ) = 1 ) ) \qquad ( Equation 10 )$$

As shown in FIG. 5, Grover diffusion operator G_{c} shown in Equation 11 may be derived from the state preparation circuit U^{p,λ} and QNNc.

$${G}_{c} = {U}^{p , λ} ( 2 \vert 0 〉 〈 0 \vert - 𝕀 ) {U}^{p , λ†} {QNN}_{c} . \qquad ( Equation 11 )$$

The measurement module may include the inverse quantum Fourier transform (IQFT or QFT⁺) module identifying the probability value of the data by superposing the quantum amplitude value of the predetermined number of qubits.

A quantum estimation circuit (QEC) may use a quantum amplitude estimation (QAE) method corresponding to Equation 12 to solve a counting problem defined for QNNc by using U^{p,λ} and G_{c}. The additional qubit (ancilla qubit) |a>, shown in FIG. 2, may be initialized to uniform superposition in a range [0, M] by the QFT. Here, M may indicate a total number of circuit calls to an oracle. Next, a controlled G_{c}²^{^{k}} gate may be applied using |aₖ> for every a.

$$QAE \vert ψ 〉 \vert a 〉 = {G}_{c}^{a} \vert psi 〉 ⊗ \vert a 〉 . \qquad ( Equation 12 )$$

After QFT⁺ is applied, an additional state (ancilla state) may be measured to acquire θ so that probability measurement has pc as in Equation 13.

$${ρ}_{c} = {sin}^{2} ( θ / 2 ) . \qquad ( Equation 13 )$$

The electronic apparatus 100 may authenticate the input data by comparing the identified probability value of the input data with the predetermined authentication radius.

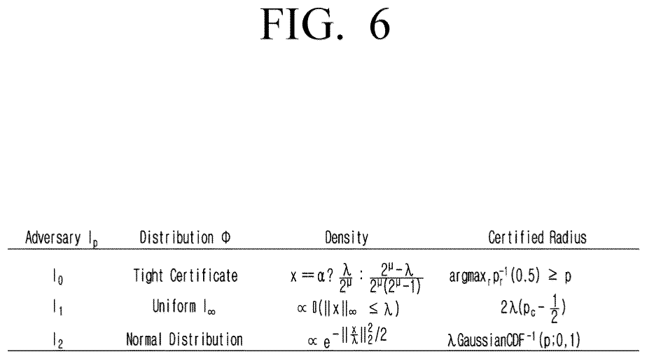

FIG. 6 is a diagram for explaining the authentication radius corresponding to an input state according to an embodiment of the present disclosure.

The input state may be classified into the lₚ norm. The norm may indicate total lengths of all vectors in a space in linear algebra. That is, the norm may indicate a distance between the vectors in a plurality of vectors, images, matrices, or the like. For example, an L₀ norm may indicate the number of a different value, an L₁ norm may indicate the sum of dimension differences, and an L₂ norm may indicate a square root of the sum of dimension squares.

In an embodiment, if vector a=(5, 8, 7, 9) and vector b=(6, 8, 7, 6), values of index 0 and index 3 of vector a and vector b are different from each other. Therefore, L₀(a, b)=2. L₁(a, b)=|5-6|+|8-8|+|7-7|+|9−6|=1+0+0+3=4. L₂(a, b)=sqrt((5−6)2+(8−8)2+(7−7)2+(9−6)2)=sqrt(1+0+0+9)=<√(10)=3.14.

Different norms may indicate different adversaries or transformed data. For example, an adversary capable of changing a fixed number of pixels may be expressed as the L₀ norm, and an adversary using Gaussian noise may be expressed as the L₂ norm.

If the input state is the L₀ norm, a state preparation circuit U^{0,λ} may smooth an arbitrary pixel having amplitude.

$$\sqrt{\frac{λ}{{2}^{v}}}$$

for a basic pixel state |α>, and include a O(v²) gate for the superposition in the remaining space.

If the input state is the L₁ norm, uniform distribution of width λ centered on pixel value α may be used for the input data. Therefore, the electronic apparatus 100 may first generate the uniform distribution from 0 to λ and then move to α. To generate a superposition state from the uniform distribution, Hadamard operator H for k-qubits may be used if λ=2k, and k∈Z.

If the input state is the L₂ norm, the L₂ norm may follow Gaussian distribution (or any other lognormal distribution), and thus use a corresponding algorithm of the state preparation module.

FIG. 6 shows the authentication radius corresponding to each input state (e.g., L₀, L₁, or L₂). The electronic apparatus 100 may authenticate the input data based on the authentication radius corresponding to the input state.

Hereinabove, the description describes the various embodiments of the electronic apparatus. Hereinafter, an example of a control method of the electronic apparatus is described.

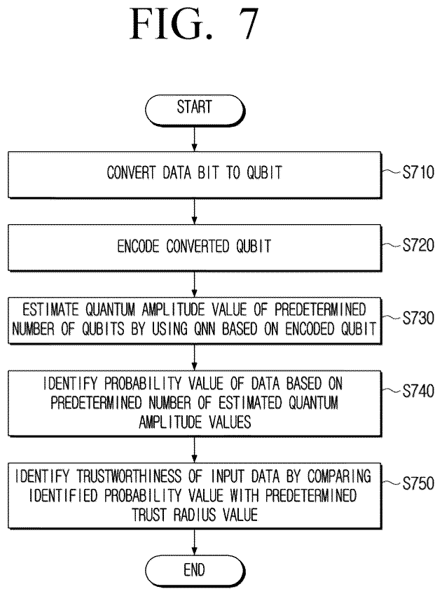

FIG. 7 is a flow chart for explaining the control method of an electronic apparatus according to an embodiment of the present disclosure.

Referring to FIG. 7, the electronic apparatus may receive the bit-format data and convert bits of the input data to qubits at operation S710. The qubits may include the plurality of state values using the quantum properties of quantum mechanics, such as superposition, interference, and entanglement.

The electronic apparatus may encode the converted qubits at operation S720. For example, the electronic apparatus may receive the first number of qubits, distribute the first number of qubits and the second number of qubits to have the predetermined distribution centered on the average of the first number of input qubits and the second number of qubits, and superpose the respective distributed qubits. The electronic apparatus may distribute the input data in different ways based on the input data state.

The electronic apparatus may estimate the quantum amplitude value of the predetermined number of qubits by using the QNN based on the encoded qubit at operation S730. The electronic apparatus may include the predetermined number of diffusion modules. In addition, each predetermined diffusion module may output the estimated quantum amplitude value. The quantum amplitude value may be estimated using the Grover search algorithm, the quantum amplitude estimation method, or a quantum machine learning method.

The electronic apparatus may identify the probability value of the data based on the predetermined number of quantum estimated amplitude values at operation S740. The electronic apparatus may identify the probability value of the data by superposing the quantum amplitude value of the predetermined number of qubits.

The electronic apparatus may authenticate the input data by comparing the identified probability value with the predetermined authentication radius value at operation S750. The predetermined authentication radius value may be a different value (or formula) based on the input state.

If an existing computing process for acquiring the same result takes O(n) time, the electronic apparatus in the present disclosure may take O(√(n)) time by using the quantum computing and encoding method, thus achieving faster data processing and processing more or complex data.

Advantageous effects of the present disclosure are not limited to those mentioned above, and other effects not mentioned here may be obviously understood by those skilled in the art from the above description.

The control method of the electronic apparatus according to the various embodiments described above may be provided as a computer program product. The computer program product may include a software (S/W) program itself or a non-transitory computer readable medium in which the S/W program is stored.

The non-transitory computer readable medium is not a medium that stores data therein for a while, such as a register, a cache, or a memory, and indicates a medium that semi-permanently stores data therein and is readable by a machine. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, or a read only memory (ROM).

Although some specific embodiments are shown and described in the present disclosure as above, the present disclosure is not limited to these specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus comprising:
an input interface; and
at least one processor configured to
receive bit-format input data using the input interface,
convert input bits included in the input data to obtain input qubits,
encode the input qubits to obtain encoded qubits,
estimate quantum amplitude values of a predetermined number of the input qubits using a quantum neural network (QNN) based on the encoded qubits,
determine a probability value corresponding to the data based on the estimated quantum amplitude values, and
authenticate the input data by comparing the determined probability value with a predetermined authentication radius value.

2. The electronic apparatus as claimed in claim 1, wherein the at least one processor comprises:
a state preparation module configured to superpose the input qubits to obtain superposed qubits,
a diffusion module group configured to estimate the quantum amplitude values using the QNN based on the superposed qubits, and
a measurement module configured to determine the probability value based on the estimated quantum amplitude values.

3. The electronic apparatus as claimed in claim 2, wherein the state preparation module is further configured to:
receive a first plurality of qubits from among the input qubits, and
distribute the received first plurality of qubits and a second plurality of qubits to have a predetermined distribution centered on an average of the first plurality of qubits and the second plurality of qubits.

4. The electronic apparatus as claimed in claim 2, wherein the diffusion module group comprises a predetermined number of diffusion modules, and
wherein each diffusion module included in the predetermined number of diffusion modules is configured to output an estimated quantum amplitude value.

5. The electronic apparatus as claimed in claim 4, wherein the diffusion module comprises at least one of a QNN module, an inverse state preparation module, a search operator module, and the state preparation module.

6. The electronic apparatus as claimed in claim 2, wherein the measurement module comprises an inverse quantum Fourier transform (IQFT) module configured to identify the probability value corresponding to the data by superposing the quantum amplitude values.

7. A method for controlling an electronic apparatus, the method comprising:
receiving bit-format input data;
converting input bits included in the input data to obtain input qubits;
encoding the input qubits to obtain encoded qubits;
estimating quantum amplitude values of a predetermined number of the input qubits using a quantum neural network (QNN) based on the encoded qubits;
determining a probability value corresponding to the data based on the estimated quantum amplitude values; and
authenticating the input data by comparing the determined probability value with a predetermined authentication radius value.

8. The method as claimed in claim 7,
wherein the encoding comprises:
receiving a first plurality of qubits from among the input qubits; and
distributing the first plurality of qubits and a second plurality of qubits to have a predetermined distribution centered on an average of the first plurality of qubits and the second plurality of qubits, and
wherein each qubit of the first plurality of qubits and the second plurality of qubits is superposed.

9. The method as claimed in claim 7, further comprising outputting the estimated quantum amplitude values,
wherein a number of the estimated quantum amplitude values corresponds to a predetermined number of diffusion modules included in the electronic apparatus.

10. The method as claimed in claim 7, wherein the determining of the probability value comprises performing an inverse quantum Fourier transform (IQFT) process determine the probability value by superposing the quantum amplitude values.
